(19) United States
(12) Patent Application Publication
(10) Pub. No.: US 2015/0331784 A1
(43) Pub. Date: Nov. 19, 2015

(54) SYSTEM AND METHOD FOR CONTROLLING TEST SCRIPT EXECUTION BY SMARTPHONE

(71) Applicants: Manjunatha Nanjundappa, Bangalore (IN); Prabhu S., Tamil Nadu (IN)

(72) Inventors: Manjunatha Nanjundappa, Bangalore (IN); Prabhu S., Tamil Nadu (IN)

(73) Assignee: Unisys Corporation, Blue Bell, PA (US)

(21) Appl. No.: 14/534,307

(22) Filed: Nov. 6, 2014

(30) Foreign Application Priority Data
May 19, 2014 (IN) 1319/DEL/2014

(51) Int. Cl. G06F 11/36

(52) U.S. Cl. CPC G06F 11/3664; G06F 11/3688

(57) ABSTRACT

A computer implemented method, and system, for selecting an appropriate test script to test software in a testing environment using a smartphone. The system fetches test scripts from a script repository as selected by a developer using a smartphone. The system executes the test script, generates an outgoing message based upon a result of executing the fetched test script, stores the outgoing message in an outgoing message buffer memory, and then transmits the outgoing message to the smartphone so the developer may review the script execution results.

### TECHNICAL FIELD

The present application generally relates to controlling execution of test scripts over a network by a smartphone.

### BACKGROUND

Software developers often develop software code in distributed-computing environments where networked computing devices may have diverse operating systems, software modules, hardware, firmware, and among other variations between components that may adversely affect compatibility of the code being developed. Similarly, software developers must develop software compatible with a vast array of public and private-enterprise environments in which networked devices may have a diverse range of components adversely affecting compatibility. What is needed is a means for testing code being developed for software products to ensure that the code underlying the software will be compatible with various components of computing devices executing the code.

In many software development efforts, code development is often performed incrementally in the form of modular components of the software, sometimes referred to as classes, objects, or some other term of art depending upon the coding language being used that refers to its modules of code as representing a part of the whole software product. In this incremental development methodology, software code may be tested for efficient and effective performance as each smaller modular portion of the whole is completed. That is, smaller portions of code are often developed through testing before incorporating them into the whole. This incremental testing methodology contrasts with waiting to test the entire software application as whole, after completing the code in its entirety.

Often, developers utilize small chunks of code, so-called scripts, as mechanisms for testing incremental code portions of the whole software. Running automated scripts across multiple platforms typically requires significant effort to individually load each of the testing scripts into each specific system having a type of platform, to then execute the test script. Often, loading and running these scripts is manually done by a developer, as opposed to being automatically selected and executed by a system. This manual task of executing test scripts across multiple platforms can be time consuming. Moreover, in some case this manual task may also fail to find “bugs” in code portions of the software earlier in code development. This can also be time consuming when there are more scripts queued for execution across each platform.

Code may be developed and tested in software development environments, which are computer programs that present friendlier programming and testing interfaces for developers. Development environments may have frameworks that allow portions of code to execute without having a complete software product, thereby facilitating testing small modules of code before the software is completed. If a testing framework is not designed properly, then collating and disseminating test scripts and test script execution results can be tedious and cumbersome.

Often, loading and running these scripts is done by a developer manually, as opposed to being automated by a system. This methodology can be time consuming, as it could take a significant amount of time to execute these tests. Often, developers manually load scripts through a program or operating system using a graphical user interface (“GUI”) at a workstation terminal. Developers are therefore required to be present at a terminal to effectuate test script execution. However, the art requires a means for developers to work efficiently from anywhere. That is, developers need to be capable of remotely administrating script testing when they are not physically located at a server or workstation associated with the test script automation system. Typically, enabling remote devices for remote administration over an ever-changing software development environment often presented problems related to providing remote access to the remote devices, and then synchronizing the remote devices with development system so that the remote devices accurately relay system information for developers to review.

What is needed is a means for allowing developers to remotely access administrative tools of a system developing software and executing test scripts. What is needed is means for facilitating automated execution of test scripts without a developer required to be physically located at a terminal for oversight. What is need is a means for allowing developers to exercise administrative duties over code development and testing from a remote location, using a variety of types of devices.

### SUMMARY

Systems and methods described herein resolve the above-describe shortcomings, and may provide a number of other benefits as well. A smartphone application may be synchronized with a software development system and a testing framework, each running at various locations in an exemplary system. Developers may use the smartphone application to control the test framework, rather than developers having to directly access the framework via a workstation. The smartphone application is a tool facilitating a developer's remote administration over a methodical and controlled execution of test scripts, but also mitigating demands for human oversight. Developers can also monitor and administrate test script execution without physically accessing terminals on the system.

In one embodiment, a computer-implemented method for testing code during software development, the method comprises fetching, by a computer, a test script from a script repository storing one or more test scripts; generating, by the computer, an outgoing message based upon a result of executing the test script; storing, by the computer, the outgoing message into an outgoing message buffer; and transmitting, by the computer, the outgoing message to a smartphone.

In another embodiment, a software development system executing test scripts, the system comprises a script repository storing one or more test scripts in a non-transitory machine-readable storage medium; a server comprising a processor and a non-transitory machine-readable memory storing instructions configuring the processor to: fetch a test script from the script repository; generate an outgoing message containing content describing a result of executing the test script; and transmit the outgoing message to a smartphone; and the smartphone comprising a processor and a non-transitory machine-readable storage medium configuring the processor to display the outgoing message received from the server on a screen of the smartphone.

In yet another embodiment, a processor-implemented method for administering software development systems remotely, the method comprises receiving, by a mobile computing device, a message containing information related to executing a test script from a server managing execution of one or more test scripts; presenting, by the mobile computing device, on a screen of the mobile computing device a notification containing the message, responsive to receiving the message from the server; generating, by the mobile computing device, a response message comprising one or more instructions for the server according to one or more selections of a developer; and transmitting, by mobile computing device, the response message to the server.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 shows a schematic diagram for an exemplary software development system executing test scripts as controlled by a smartphone.

FIG. 2 shows a flowchart displaying logical steps of executing a method embodiment of executing test scripts by computing devices comprising any number of processors and non-transitory machine-readable storage memory.

FIG. 3 shows a flowchart displaying logical steps of a method embodiment for remotely controlling test script execution, as performed by a smartphone in a system hosting a software development environment.

### DETAILED DESCRIPTION

Reference will now be made in detail to several preferred embodiments, examples of which are illustrated in the accompanying drawings. The embodiments described herein are intended to be exemplary. One skilled in the art recognizes that numerous alternative components and embodiments may be substituted for the particular examples described herein and still hill within the scope of the invention.

It should be appreciated scripts may refer to software development tools, software code, and other machine-readable files prepared to effectively test certain aspects of a larger software development project. Although test scripts are particularly useful in larger object-oriented software development efforts, it should be appreciated that test scripts, code, software, processes, and modules are not intended to be limiting to large object-oriented software.

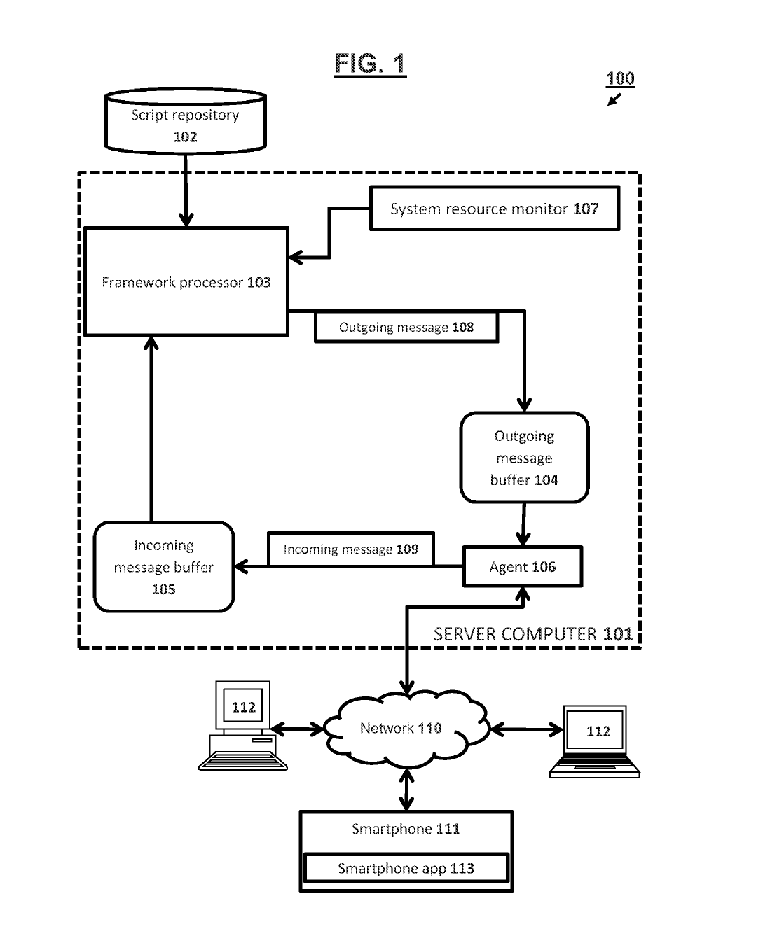

FIG. 1 shows a schematic diagram for an exemplary software development system 100 executing test scripts as controlled by a smartphone 111. The exemplary embodiment of FIG. 1 comprises a server 101 and smartphone 111, which communicate with one another over a network 110.

A server 101 may be any computing device comprising processors, non-transitory machine-readable memory, and/or software modules making embodiments of the server 101 capable of executing various tasks and processes described herein. The server 101 may be any computing device 101 placed in a logically central location of a computing network 110 such that the server 101 may be in networked communication with various other modules and devices 112 residing on the system 100. The server 101 may execute a collection of one or more test scripts in order to test portions of computer code, which may be modular portions of a larger software project under development. When executing test scripts, the server 101 may subject code portion to the test scripts in order to verify proper functionality of the tested code portions.

The server 101 may be capable of communicating results of the automated script testing to a developer by displaying execution results onto a human-readable presentation. Script executions results may be displayed on a user interface on the screen of the developer's smartphone 111. The server 101 may comprise hardware and software components for managing, administering, and performing test script executions. The smartphone 111 may comprise a smartphone app 113 executed by a processor of the smartphone 111. The smartphone app 113 may instruct the server 101 on how to proceed with testing.

Embodiments of the system 100 may comprise a script repository 102, which may be a non-transitory machine-readable storage medium capable of storing test scripts used to test the functionality of portions of code for software being developed. The server 101 may comprise the script repository 102. The script repository 102 may be a text file containing each of the test scripts. In some embodiments, the script repository 102 may be a sophisticated database having database management system and corresponding logical structure. The script repository 102 may be on distinct physical device comprising a processor and non-transitory machine-readable storage medium distinct from the server 102.

The server 101 may comprise a framework processor 103 performing execution of test scripts. In some embodiments, the framework processor 103 may bundle outgoing messages 108 for reporting results of executing test scripts, which may be transmitted over a network 110 to a smartphone 111. At runtime, the framework processor 103 may fetch a test script that is stored in a script repository 102. The framework processor 103 may then execute the fetched test script.

The framework processor 103 on a server 101 may execute a framework module, which may be any software testing tool and/or software development tool (e.g., Eclipse®, Apache Bean Scripting Framework®) capable of allowing test scripts to execute specific portions of software code for testing those specific portions of code. It should be appreciated that other devices 112 on the system 100 may comprise a framework processor 103 implementing the framework for testing. The framework may be open source, commercially available, or natively designed for the system 100. The framework may be stored on a server computer 101 or any other devices 112 on the system 100 comprising a non-transitory machine-readable storage medium. The framework may stored on any memory of the system capable of responding to requests by the server 101, smartphone 111, or other devices 112 in the system 100 to transmit the framework. The framework may be stored in a compressed format on the server 101, or on other memory of the system 100, until the framework is transmitted to a requesting device or otherwise called for executing a test script. The devices 112 may decompress the framework and install the framework in order to execute the test scripts.

As discussed below, in some embodiments, whenever a framework processor 103 detects an unexpected error associated with the execution of a particular test script, the framework processor 103 may store error data related to the unexpected error, such as the window name, buttons, and error message, into an outgoing message 108. It should be appreciated that examples of possible error data are not limited to windows, buttons, and error message. It should be appreciated that the error data might be any information relating to the server 101 execution of the test script, and the results thereof. Results of test script execution received from a device may include indication of pass/fail status of the execution, as well as errors relating to server 101 resource errors.

An outgoing message 108 may be generated by the framework processor 103 upon detection of the error. In some embodiments, the outgoing message 108 may be a text file composed of the error data, or alternatively, the outgoing message 108 may be part of a bundle of application data required to adequately construct a graphical user interface (“GUI”) displayed by a smartphone app 113.

The server 101 may comprise a system resource monitor 107, which may be a software module that may determine whether a resource of the server 101 requested to be involved in executing test script will be available to the test script to utilize. For example, in one case the test script may be testing the software's ability to open a web browser, or in another case the software's ability to retrieve a word processing document. The system resource monitor 107 will recognize whether the requested resources (e.g., a web browser, a word processing document) are available to the test script execution to properly execute the test script testing such resource requests from the code of the software that is being tested. It should be appreciated that a system resource monitor 107 can be any means for monitoring the usability or availability of a resource that may be requested by portions of code of software. Non-limiting examples of a resource may include a machine-readable file, a device, a software application, a network computing-service, among other computer resources.

As mentioned previously, portions of code may utilize various resources by using resource calls that are native to code languages, which are represented in the portions of code. Test scripts executed by a framework processor 103 of a server 101 may be designed to test the efficacy of these portions of code. In some circumstances, resources utilized by the server 101 may be strained when the server 101 proceeds to execute test scripts, thereby rendering the resources unavailable to the framework processor 103 executing the test scripts testing the code portions. In some cases, any number of other failures may arise, which may render resources unavailable. A system resource monitor 107 may automatically detect the unavailability of resources. In some embodiments, the system resource monitor 107 may transmit to the framework processor 103 a warning that notifies the framework processor 103 that resources are unavailable, or that resources of the sever 101 are strained, for executing test scripts requesting the unavailable resources. The framework 103 may bundle the warning into an outgoing message 108, and then place the outgoing message 108 into an outgoing message buffer 104 where the outgoing message 108 awaits transmission to a smartphone 111.

In some circumstances, execution of test scripts may cause an error of resources of a server 101 (e.g., unable to locate file directory, insufficient memory). The framework processor 103 may receive a system error dialog comprising error data related to the error from a system resource monitor 107 that may have automatically detected the error. The framework processor 103 may bundle the system error dialog and error data into an outgoing message 108. The framework 103 may place the outgoing message 108 into an outgoing message buffer 104 to await transmission to a smartphone 111 of a developer.

Some embodiments of a server 101 may execute an agent software module, or agent 106. The agent 106 may continuously monitor an incoming message buffer 105 and an outgoing message buffer 104. Embodiments of the incoming message buffer 105 and the outgoing message buffer 104 may be any non-transitory machine-readable storage medium capable of storing messages exchanged over a network 110. It should be appreciated that one or more processors may execute one or more agent 106 tasks, such as continuously monitoring each of the message buffers 104, 105, and may still be within the scope of the agent 106 or other aspects of the server 101. In some embodiments, the agent 106 may be a component of the server 101 and in some embodiments, the agent 106 may be on a distinct physical device. In some embodiments, either or both of the message buffers 104, 105 may be components of the server 101, and in some embodiments, either or both of the message buffers 104, 105 may be components of distinct physical devices 112.

An outgoing message buffer 104 may be a non-transitory machine-readable storage medium capable of storing outgoing messages 108 generated by a framework 103. Outgoing messages 108 may be transmitted to a smartphone 111. The smartphone 111 may execute a smartphone app 113 configured to display the outgoing messages 108 to a developer who may be operating the smartphone 111. An agent 106 may automatically detect an outgoing message 108 being stored, or queued, into the outgoing message buffer 104. The agent 106 may transmit to the smartphone 111 outgoing messages 108 detected by the agent 106 as being queued in the outgoing message buffer 104.

An incoming message buffer 105 may be any non-transitory machine-readable storage medium capable of storing incoming messages 109 received from a smartphone 111. In some embodiments, incoming messages 109 may be generated by the smartphone 111, intended to be forwarded to a framework processor 103 of a server 101. The smartphone 111 may execute a smartphone app 113 configured to generate incoming messages 109 and then transmit generated incoming messages 109 over a network 110 to the server 101. The agent 106 on the server 101 receives the incoming messages 109 and may store, or queue, the incoming messages 109 into the incoming message buffer 105 until the framework processor 103 is available to review the queued incoming message 109.

A smartphone 111 device may be any handheld, telecommunications-enabled device capable of remotely communicating with a server 101 over a network 110. The smartphone 111 may comprise a processor and a non-transitory machine-readable storage medium such that embodiments of the smartphone 111 may have computer or computer-like functionality. It is to be appreciated that the smartphone 111 is not intended to be limited to a cellular telephone. In some embodiments, the smartphone 111 may be a portable tablet or other compact computing device capable of executing tasks described herein.

The smartphone 111 may execute a smartphone app 113, which may be a software application module designed to be executed by the smartphone 111. It should be appreciated that the smartphone 111 may be any mobile device satisfying one or more embodiments as described herein, as such it should be appreciated that the smartphone app 113 may be a software module designed to be executed by the particular mobile device executing the smartphone app 113 (e.g., tablet, laptop).

A smartphone app 113 may facilitate developer interactions with a server 101 for remotely controlling administrative aspects of executing test scripts. In some embodiments, the smartphone app 113 may facilitate developer interactions for remotely monitoring and managing other technical aspects of the system 100. For example, the smartphone app 113 may remotely facilitate a developer's operation of, and provide administration over, the framework processor 103 and the server 101. The smartphone app 113 may display a GUI allowing developers to interact with any number of computing devices 112 in the system 100. The smartphone app 113 may receive, from the server 101, various alerts and other types of outgoing messages 108 related to executing test scripts and system functionality 101). In some cases, the GUI presented by the smartphone app 113 may allow developers to review outgoing messages 108 received from the server 101, in a human-relatable format.

Developers may use the GUI to transmit administrative instructions to a server 101, and to select a response to outgoing messages 108 received from a server 101. After a developer selects a response to a outgoing message 108, the smartphone 111 packages the response into instructions for the server 101 to perform. Administrative instructions may also be packaged as instructions for the server 101 to perform. The smartphone 111 may transmit such instructions to the server 101 as incoming messages 109. An agent module 106 on the server 101 may receive an incoming message 109 comprising instructions generated from the GUI of the smartphone app 113. The agent 106 may store the incoming message 109 into an incoming message buffer 105.

Outgoing messages 108 and/or incoming messages 109 may be based on message templates. A message template may be a standard template used to quickly report information regarding a particular activity. Examples of an activity may include starting an execution, stopping execution, starting a framework, stopping a framework, and templates relating to error handling, There may be a message template for each unique activity performed by a component of the system 100. There may be a message template used when reporting a status for each component within the system 100. There may be a message template used by a smartphone app 113 for transmitting various instructions or responses to notifications, to the server 101. It should be appreciated that templates are not limited to text notifications or reporting forms, but may contain dynamic code or other machine-readable formats.

For example, message templates may include buttons, links, and other interactive dialog. Templates may also be based upon the type of content contained in a outgoing message 108 or an incoming message 109. For example, message templates used for messages from the framework processor 103 may include an informational template, which may contain a status for test script execution and may also contain test script results at the moment, an error template, which may contain error data conveying informative details regarding errors, and a warning template, which may show data describing a system warning (e.g., system resource is unavailable for testing but test script may continue executing). Message templates may contain interactive aspects, as well. For example, an error template may include a button or link for a developer to select, which presents an error dialog displayed on the receiving device (e.g., server 101, devices 112, smartphone 111).

Examples of message templates used for messages from the smartphone app 113 to the server 101 may include a click template, which may be contain commands for the server 101 based on a selection (e.g., a particular button) from a GUI-error window presented on a screen of the smartphone 111, a command line template, which may contain commands for the server 101 to perform in a command line format, and a request template, which may contain a request for the current execution status from server 101.

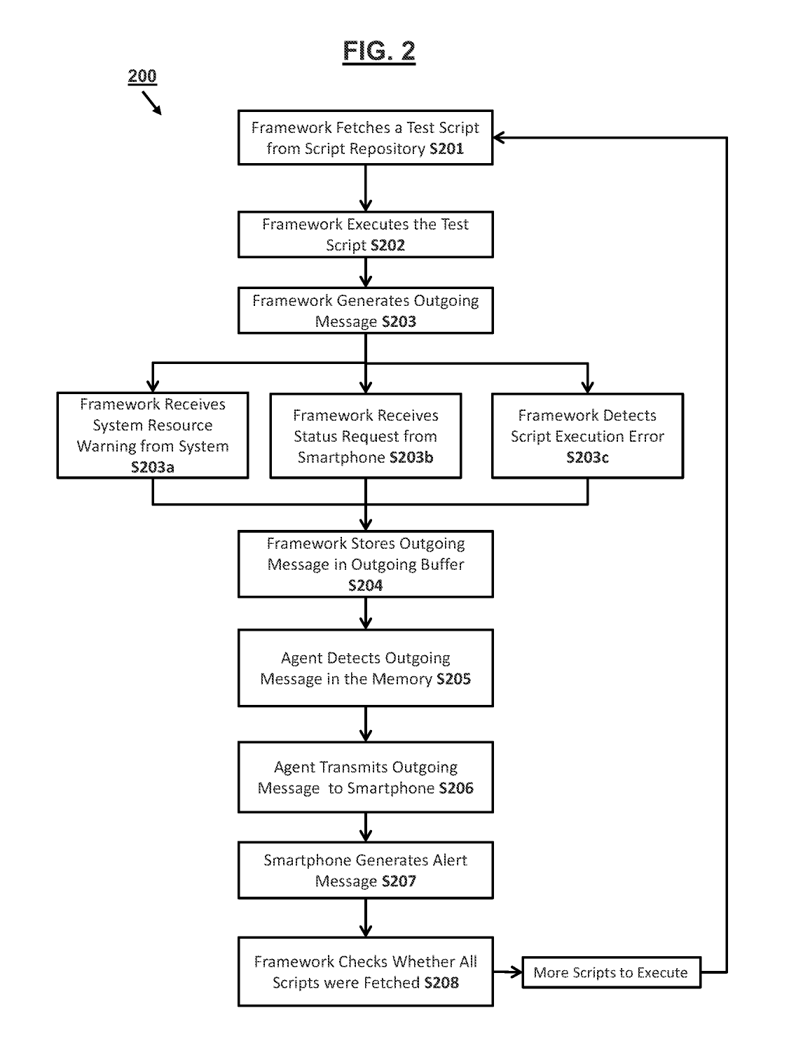

FIG. 2 is a flowchart showing logical steps of executing a method embodiment of executing test scripts by computing devices comprising any number of processors and non transitory machine-readable storage memory.

In a first step S201, a framework software module hosted on a server may retrieve test scripts stored in a script repository. The server may retrieve the A script repository may be any computing device comprising non-transitory machine-readable storage medium, processors, and/or software modules capable of executing various tasks associated with the script repository described here. For example, the script repository may be database comprising a structure storage schema and database management model (e.g., SQL). As another example, the script repository may be a text file containing each of the test scripts.

In a next step S202, the framework of the server may execute a test script retrieved from a script repository, against a portion of software code.

In a next step S203, the framework of the server may generate an outgoing message for transmission to a smartphone of a developer. The framework may prepare an outgoing message based on a successful execution of a test script. Outgoing messages may be prepared in response to one or more triggering circumstances S203a, S203b, S203c. For example, the framework may encounter an unexpected error (e.g., unavailable resources requested) during test execution. In such cases, the framework may place error data related to the unexpected message into an outgoing message.

In determination S203a, the framework receives a system warning from a system resource monitor of the server. When the framework receives the system warning, the framework generates an outgoing message containing the system warning message and related error data. For example, a warning may be generated when one or more portions of software code may not be appropriately coded according to best practices, or a system resource utilized by the tested code may be strained, or other situation in with test script execution may proceed forward but potential problems may be present in the system, devices, or code.

In determination S203b, the framework receives a request for a test script execution status from a smartphone. That is, in some cases, developers may wish to determine the status of a large test script execution project. The smartphone may transmit the status request inquiring as to the present status executing test scripts. An agent module on the server may receive from the smartphone, an incoming message comprising the status request. The agent may store the incoming message into a message buffer. The framework may receive the request from message buffer, and in response the framework identifies the script execution status of one or more test scripts according to the request. The framework may then generate an outgoing message containing the script execution status that is responsive to the status request received. The framework may automatically generate an outgoing message containing a script execution status after each test script executes, which may be transmitted according to certain user preferences without requiring a prompting request.

In determination S203c, according to some embodiments, the framework may detect a script execution error and puts the error data into an outgoing message. The error data is the pertinent information regarding the error detected by the framework. For example, if a test script is testing a portion of code that is ultimately intended for generating a user interface, error data produced when executing the requisite test script may include a name of a window, buttons, and an error message generated by the server when certain resources needed for execution are unavailable, such as code libraries related to building aspects of graphical interfaces.

In a next step S204, the framework stores an outgoing message into an outgoing message buffer to await transmission to a developer's smartphone. An agent module may continuously monitor the outgoing message buffer awaiting the framework to place outgoing messages into the outgoing message buffer. It should be appreciated that the agent may be a software module capable of continuously monitoring the outgoing message buffer. In some embodiments, the agent may be on the same physical device as the storage media of the outgoing message buffer. In some embodiments, the agent may be on a distinct physical device from the outgoing message buffer.

In a next step S205, the agent monitoring the outgoing message buffer may automatically detect an outgoing message being stored in the outgoing message buffer. Upon detecting the outgoing message, the process may progress to a next step S206. In step S206, the agent may automatically prompt the server to transmit the outgoing message to the smartphone. In some embodiments, before transmission of the outgoing message, the agent may query a smartphone app to determine whether the smartphone app is prepared to receive the outgoing message.

In a next step S207, a smartphone of a developer receives an outgoing message from the agent of the server. The smartphone comprises a smartphone app that may generate a notification informing the developer the smartphone received the outgoing message from the server. The notification may utilize various alerting mechanisms native to the smartphone in accordance with user preferences set by the smartphone app (e.g., vibrating, home screen notifications, ringtone playback).

In a next step S208, the framework may determine whether each test script in the script repository, or in selection of scripts to be executed according to a developer setting, have been fetched and executed. The framework may fetch and execute test scripts from the script repository, one-at-a-time. After a test script is executed, the framework must determine whether a next test script remains to be fetched from the script repository. In the event the framework determines that a test script has not already been fetched and executed, the framework may loop the process to a step S201 for fetching the next test script. The framework may continue to return to step S201 until each of the test scripts in the script repository, or otherwise selected for executions, are fetched and executed.

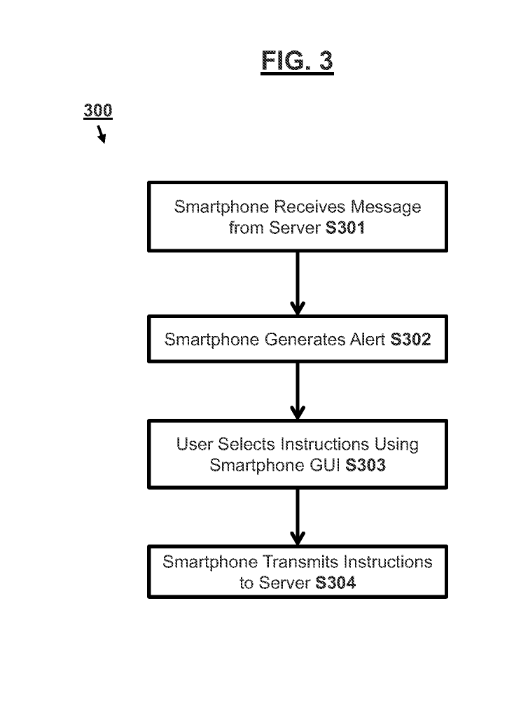

FIG. 3 is a flowchart showing logical steps of a method embodiment for remotely controlling test script execution, as performed by a smartphone in a system hosting a software development environment.

In a first step S301, a smartphone receives, from a server, an outgoing message containing information related to executing test scripts. Information related to test scripts may include error data, results, execution status, and status of system components. The server may execute test scripts and transmit the outgoing messages to the smartphone. One or more devices in the system may execute test scripts and report results to the server. In some embodiments, the smartphone comprises a smartphone app that is designed to communicate with the server. The smartphone app may send and receive information and instructions relating to executing test scripts. The smartphone app may send instructions to the server, such as responses to various notifications.

In a next step S302; the smartphone may generate a notification informing a developer that the smartphone received a message from a server, which may otherwise be referred to herein as an outgoing message taken from the perspective of the server. The notification may contain information relating to test script execution, Outgoing messages received from the server may based on templates that the server changes to suit the present circumstances. Templates may be pre-packaged informational messages that may be amended accordingly prior to transmitted to the smartphone. In some embodiments, the notification may contain the outgoing message from the server. As such, templates may be used for predictable formatting on the smartphone, and for consistency of the notifying phrases.

In some embodiments, a smartphone app of the smartphone may be used to control interactions between the smartphone and the server. In some embodiments, the smartphone app may generate the notification according to the outgoing message received from the server. In some embodiments, the smartphone app may allow developers to select alarm mechanisms native to the smartphone to accompany notifications. Examples of alarm mechanisms may include attention-grabbing sounds, vibration, and flashing lights. The notifications may comprise at least a portion of the outgoing message, which may convey information regarding test script execution by the server. After receiving the notification, the developer may access a GUI presented by the smartphone app in order to select a response.

In a next step S303, the developer may use a GUI of a smartphone app to select a desired response to a notification, which in some cases may include instructions. The smartphone app may package the response into an incoming message, and then transmit the incoming message to the server. The smartphone app may use incoming message templates for preparing the incoming message. Incoming message templates may correspond or be otherwise related to various outgoing message templates, such as a standardized look-and-feel, or an automatically predetermined template corresponding to a particular error reported within the outgoing message.

In a next step S304, after a response and instructions are packaged into an incoming message in accordance with the developer's selections, the smartphone may then transmit the incoming message to the server. An agent module of the server may receive the incoming message and store the incoming message into an incoming message buffer to await the attention of a framework processor of the server.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers, Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention, Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for testing code during software development, the method comprising:
fetching, by a computer, a test script from a script repository storing one or more test scripts;
generating, by the computer, an outgoing message based upon a result of executing the test script;
storing, by the computer, the outgoing message into an outgoing message buffer; and
transmitting, by the computer, the outgoing message to a smartphone.

2. The method according to claim 1, further comprising, detecting, by the computer, an error relating to executing the test script, wherein the result is the error, and wherein the outgoing message contains error data describing the error.

3. The method according to claim 1, further comprising, determining, by the computer, a status for one or more resources required for executing the test script.

4. The method according to claim 3, wherein the outgoing message contains information relating to the status of the one or more resources for executing the test script.

5. The method according to claim 1, further comprising receiving, by the computer, from the smartphone a request for a status related to executing the test script, wherein the outgoing message contains information responsive to the request for the status.

6. The method according to claim 1, further comprising determining, by the computer, whether there is a next test script that has not been executed stored in the script repository, wherein the method repeats when the script repository contains at least one next test script that has not been executed.

7. The method according to claim 1, further comprising performing, by the computer, one or more instructions received in an incoming message from a smartphone.

8. The method according to claim 1, further comprising:
determining, by the computer, a template associated with the outgoing message according to a type of content contained in the outgoing message; and
formatting, by the computer, the outgoing message according to the associated template,
wherein the template is stored in a non-transitory machine-readable storage medium storing one or more templates each associated with at least one content type.

9. A software development system executing test scripts, the system comprising:
a script repository storing one or more test scripts in a non-transitory machine-readable storage medium;
a server comprising a processor and a non-transitory machine-readable memory storing instructions configuring the processor to:
fetch a test script from the script repository;
generate an outgoing message containing content describing a result of executing the test script; and
transmit the outgoing message to a smartphone; and
the smartphone comprising a processor and a non-transitory machine-readable storage medium configuring the processor to display the outgoing message received from the server on a screen of the smartphone.

10. The system according to claim 9, wherein the processor of the server is further configured to continuously monitor a status related to executing the test script.

11. The system according to claim 10, wherein the processor is further configured to automatically detect the status for executing the test script is an error associated with executing the test script, and wherein the result contained in the outgoing message comprises error data associated with the error.

12. The system according to claim 9, wherein the processor of the smartphone is further configured to transmit to the server an incoming message containing one or more instructions for the server.

13. The system according to claim 12, responsive to receiving an incoming message from the smartphone containing a request for a status related to executing one or more test scripts:
the processor of the server is further configured to generate an outgoing message containing the status related to executing the one or more test scripts.

14. The system according to claim 12, wherein the one or more instructions of the smart phone comprises a system operation command.

15. The system according to claim 9, wherein the outgoing message comprises a graphical user interface for the smart phone to facilitate human selection of which action instruction to execute.

16. The system according to claim 9, further comprising a template repository storing one or more templates each associated at least one type of content,
wherein the processor of the server automatically determines a template in the template repository associated with the type of content in the outgoing message, and
wherein the outgoing message is formatted according to the template.

17. A processor-implemented method for administering software development systems remotely, the method comprising:
receiving, by a mobile computing device, a message containing information related to executing a test script from a server managing execution of one or more test scripts;
presenting, by the mobile computing device, on a screen of the mobile computing device a notification containing the message, responsive to receiving the message from the server;
generating, by the mobile computing device, a response message comprising one or more instructions for the server according to one or more selections of a developer; and
transmitting, by mobile computing device, the response message to the server.

18. The method according to claim 17, further comprising:
generating, by the mobile computing device, a request for the message containing information related to executing the test script based on a selection of the developer; and
transmitting, by the mobile computing device, the request for the message to the server.

19. The method according to claim 17, further comprising formatting, by the mobile computing device, the response using a template.
